(19) United States
(12) Patent Application Publication
(10) Pub. No.: US 2007/0068898 A1
(43) Pub. Date: Mar. 29, 2007

(54) Multi-level etching method and product

(76) Inventor: Glen Douglas Lorenz, West Saint Paul, MN (US)

Correspondence Address: Thomas N. Phung;Jacobson and Johnson, Suite 285, One West Water Street, St. Paul, MN, 55107-2080, US

(21) Appl. No.: 11/239,558

(22) Filed: Sep. 29, 2005

(51) Int. Cl. G01D 15/00; G11B 5/127

(52) U.S. Cl. 216/27

(57) ABSTRACT

A method and product of etching a multi-level substrate, the method comprising the steps of printing an image on a substrate having two different surface levels with an ink jet printer containing an ink jettable etchant resist, curing the ink jettable etchant resist on the substrate to leave an etchant protected region and an etchable region on the substrate, and etching the substrate in the etchable region to thereby provide the substrate with an additional etched surface level with the additional etched surface level having a different elevation than at least one of the original surface levels.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### FIELD OF THE INVENTION

This invention relates to etching, and more specifically, to a method for manufacturing multi-level dies through the use of an etchant-resist ink and a product thereof.

### BACKGROUND OF THE INVENTION

Embossing is a traditional technique in which a male die and a female die are placed in a pressing machine such as printing press and then brought together by the press to raise and/or recess images out of materials such as paper, sheets of vinyl, plastic, polycarbonite, leather and various other sheet goods. The dies used for embossing are typically formed by a process in which a negative or positive of an image to be embossed is laid over a piece of metal having a coating of a photo sensitive monomer-containing etchant resist and exposing the metal with the photo sensitive monomer-containing etchant resist coating to a light source. The image is developed and the metal is prepared for etching. The metal is then placed in an acid bath that etches away areas of the metal that were not exposed to light thereby producing a single level embossing die.

More specifically, in the above-mentioned embossing die forming process, the negative or positive of the image to be embossed, which is also referred to as an image template, is initially laid over a surface of a metal plate having a coating of a photo sensitive monomer-containing etchant resist located thereon. It is noted that the metal plate can comprise magnesium, zinc, brass, copper, or aluminum. It is further noted that the image template comprises areas that are opaque and areas that are transparent.

The image template and metal plate are then placed in a vacuum chamber to increase the surface contact between the image template and the metal plate. The image template and metal plate are then exposed to ultraviolet light. Areas of the metal plate to remain un-etched are defined by the transparent areas of the image template, which allow ultraviolet light to strike and polymerize or cure the photosensitive monomer etchant resist covering the metal surface. Areas of the photosensitive monomer-containing etchant resist on the metal plate that were unexposed to the ultraviolet light, i.e. located under the opaque areas of the image template, are then easily removed from the metal plate, such as through a developing process, as they were not cured or polymerized by the ultraviolet light exposure. The metal plate is descummed to remove dirty developer and other residue from the developing process. The metal plate containing the polymerized or cured etchant resist is then placed in an acid bath which etches away areas of the metal plate that are not coated with the polymerized or cured etchant resist thereby producing a single level embossing die.

Although the above method is effective at producing single level embossing dies, the aforementioned method includes limitations preventing it from producing multi-level dies with the precision required for the embossing art. For example, one of the limitations of the above method comprises the problem of exposing a subsequent template containing the image of the next areas to be etched. More specifically, the aforementioned method requires that the template (film) emulsion be in contact with the polymer emulsion (etchant resist coating) on the plate. Because it is very difficult to draw the template sufficiently tight to the metal plate to have the template cover the recesses made in the first etching pass, there will be unsatisfactory contact. The result will be an inaccurate exposure resulting in an unsatisfactory etching.

It has been found that UV-curable inks, which have been used in the printing industry for printing long lasting images on substrates such as plastics and generally comprised of three primary components, namely, monomers, oligomers and photo-inhibitors, when polymerized or cured on the substrate to be etched, can function as an effective etchant resist to the acid bath used in the above etching process.

In general regards to the three primary components of the UV-curable ink, the monomers are organic solids and are reactive dilutant with a low molecular weight which create a homogenous solution and impart the surface characteristics of the ink. In regards to the oligomers, the oligomers form the chemical frame of the UV-curable inks and determine the final properties of the cured ink layer applied to a substrate including the ink layer's flexibility, weather resistance and chemical resistance. Finally, the photo-inhibitors control the start and completion of the ink curing process as they absorb ultra-violet energy from a light source focused at the print surface that causes the photo-inhibitors to fragment into reactive materials. The aforementioned starts a process called polymerization, which comprises a chemical reaction that converts liquid ink into a solid, which adheres to the surface of the substrate to be etched.

It has also been discovered that that above mentioned UV-curable ink, when used in inkjet printers, such as flatbed inkjet printers that are popular in the printing industry because they allow for the printing of an image on a substrate having varying surface levels, allow for the printing of the UV-curable ink on a wide range of substrates used in the embossing art.

In regards to the above-mentioned UV inkjet printer, it is noted that the above-mentioned UV inkjet printing hardware is commercially available from a number of sources including Minnesota Mining, and Manufacturing Company (3M) of Saint Paul, Minn. and Mimaki Engineering Co., Ltd of Tokyo, Japan.

In regards to the general operation of the above UV inkjet printer, a substrate is first placed on the printing bed of the UV inkjet printer after which the UV inkjet printer receives information from the computer to determine the precise position of the substrate on the printing bed. An electronic image to be printed onto the substrate is entered into a computer linked to and controlling the UV inkjet printer. Once the image is entered, the computer then sends information to the UV inkjet printer to initiate the printing process. During the printing process, a printer head of the UV inkjet printer moves along the substrate leaving droplets of the UV-light curable etchant resist on demand. As the droplets of UV-curable ink are applied to the substrate, an Ultraviolet light source located proximal the printer head of the UV inkjet printer exposes the UV-curable ink to Ultraviolet light rays to polymerize or cure the UV-curable ink to the substrate.

### BRIEF SUMMARY OF THE INVENTION

The present invention comprises a method and a product of etching a substrate to form a multi-level substrate suitable for use as an embossing die. The aforementioned method generally comprises the steps of printing a precise image on a substrate having at least two different surface levels with an ink jet printer containing an ink jettable etchant resist and etching the substrate in an etchable region to thereby provide a substrate with an additional level.

The above method can also include the step of positioning the substrate on a printing bed of the ink jet printer; curing the ink jettable etchant resist to leave an etchant protected region and the etchable region on the substrate; applying a pre-etch descum to the etchable region of the substrate; applying a post etching process; and stripping the cured ink jettable etchant resist from the surface of the substrate. The aforementioned steps can be repeated if desired in order to etch each subsequent level of depth on the substrate. The product of the present invention comprises a substrate having a surface with at least two surface levels having different elevations. The substrate surface includes an etchant resist pattern printed thereon by an inkjet printer containing an ink jettable etchant resist, the etchant resist pattern covering selected regions of the substrate surface so that exposure of the substrate to an etchant produces an additional level thereby making the substrate suitable for use as a multilevel embossing die.

### DESCRIPTION OF THE PRIOR ART

U.S. Pat. No. 4,131,663 teaches a process for mechanically embossing a pattern on a floor covering material.

U.S. Pat. No. 4,155,627 teaches fine-detail multi-level patterns fabricated by linearly adding or subtracting an additional pattern to an existing multi-level pattern through evaporation or by linearly subtracting an additional pattern to an existing multi-level pattern through sputter or plasma etching.

U.S. Pat. No. 4,213,819 teaches a method of making an embossing tool for the embossing of plates, sheets or foil.

U.S. Pat. No. 4,294,650 teaches a method of forming an embossing tool for applying contour to synthetic-resin plates, sheets or foil to produce a leather-like or wood-like pattern therein.

U.S. Pat. No. 4,959,275 teaches a process and an equipment for micro-pattern forming on the surface of a rolling roll, and a metallic thin sheet and preparation thereof by transferring a micro-pattern on the surface through the use of the roll.

U.S. Pat. No. 5,298,116 teaches a single and multiple step etching to form single or multiple layered surface structures on embossing plates.

U.S. Pat. No. 6,402,403 teaches a method of 3-dimensional printing using an inkjet or plotter type apparatus and in some embodiments uses ultraviolet light or infrared radiation to cure the ink. The use of the apparatus for applying an etchant resist for dry etching is described.

U.S. Pat. No. 6,754,551 teaches an apparatus and method for depositing various patterns on printed circuit boards using jet-dispensing technology.

U.S. Pat. No. 6,746,946 teaches a method and apparatus for producing printed circuits utilizing direct printing methods to apply a pattern mask to a substrate.

### BRIEF DESCRIPTION OF THE DRAWINGS

FIG. 1 is a schematic flow diagram showing a method of etching for forming a multi-level embossing die of the present invention;

FIG. 2 is a side view showing an un-etched substrate during the etchant resist printing process by a UV inkjet printer;

FIG. 3 shows a side view of the substrate of FIG. 2 after the completion of the etchant resist printing and curing process;

FIG. 4 shows a side view of the substrate of FIG. 3 after the an exposure to an etchant;

FIG. 4A is a side view showing a single etched substrate stripped of the etchant resist;

FIG. 5 is a side view showing the single etched substrate of FIG. 4A during the etchant resist printing process by a UV inkjet printer;

FIG. 6 shows a side view of the etched substrate of FIG. 4A after the completion of the etchant resist printing and curing process;

FIG. 7 shows a side view a multi-level substrate suitable for use as an embossing die;

FIG. 8 shows a schematic flow diagram of an alternative embodiment of a method of forming a multi-level embossing die;

FIG. 9 shows a side view of an image template supported on a coating of a photosensitive etchant resist located on a surface of an un-etched substrate;

FIG. 10 shows a side view of the image template and the un-etched substrate being exposed to ultraviolet light via a UV lamp;

FIG. 11 shows a side view of the un-etched substrate having regions covered with a cured etchant resist;

FIG. 12 shows a side view of the substrate of FIG. 11 after the an exposure to an etchant; and

FIG. 13 shows a side view of a single etched substrate of FIG. 12 stripped of the cured etchant resist.

### DESCRIPTION OF THE PREFERRED EMBODIMENT

The present invention comprises a method and product of etching a substrate to form a multi-level die, such as but not limited to embossing dies, through the employment of an inkjet printer dispensing organic monomers and oligomers, such as acrylates, in the form of liquid inks, which are polymerized or cured by ultraviolet light and used as etchant resist to define areas to be etched. In regards to the UV inkjet printer used in the present invention, while it is noted that UV inkjet printing hardware from a number of sources can be used with the present invention, the Mimaki UV curable Inkjet Printer, Model Number UJF-605C produced and sold by Mimaki Engineering Co., Ltd of Tokyo, Japan was used in the present invention due to the aforementioned printer's high precision capabilities.

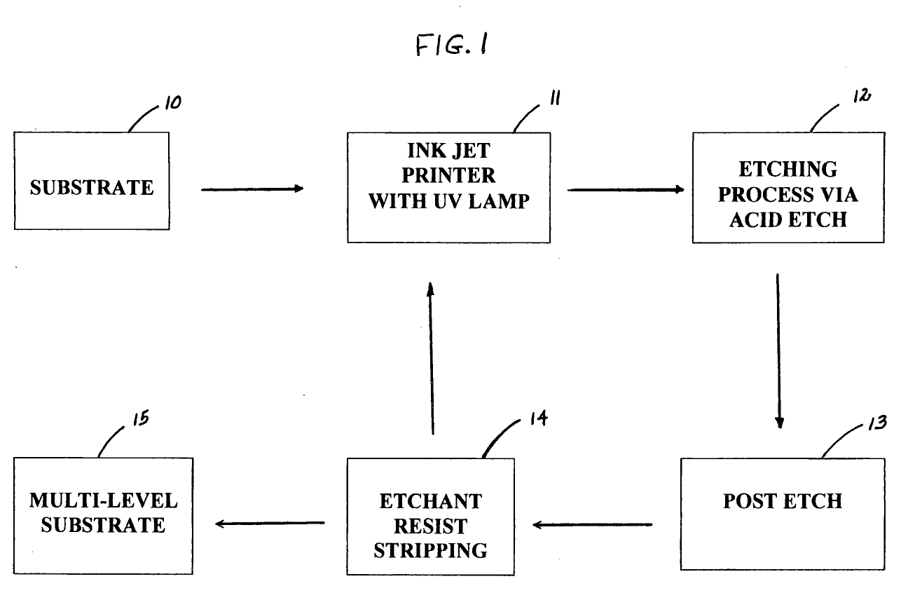

FIG. 1 is a schematic flow diagram showing a method of etching of the present invention for forming a multi-level embossing die. As shown in FIG. 1, the method initially starts with the placement of a substrate 10 on a printing bed (not shown) of a UV inkjet printer 11. It is noted that various types of die substrates can be used with the method of the present invention including but not limited to magnesium, zinc, brass, copper, stainless steel, and aluminum based substrates.

After substrate 10 is placed onto the printing bed of UV inkjet printer 11 containing an ink jettable etchant resist, UV inkjet printer 11 reads software to determine the precise position of the substrate 10 on the printing bed. An electronic image to be printed onto a surface 16 of substrate 10 is contained in a computer (not shown) linked to and controlling UV inkjet printer 11. The computer sends information to UV inkjet printer 11 to initiate the printing process.

Referring to FIG. 2, during the printing process a printer head 17 of UV inkjet printer 11 moves along substrate 10 leaving droplets of the UV-light curable etchant resist 18 on demand to selected regions on surface 16 of substrate 10. It is noted that one method of the aforementioned is known as piezoelectric printing, which utilizes vibration of small crystals in the nozzles of the printing head to dispense the UV-light curable etchant resist 18.

As the droplets of UV-light curable etchant resist 18 are applied to surface 16 of substrate 10, an ultraviolet light source 31 located proximal the printer head of the UV inkjet printer exposes UV-light curable etchant resist 18 dispensed on surface 16 of the substrate 10 to UV light to polymerize or cure UV-light curable etchant resist 18 to surface 16 of substrate 10. In regards to ultraviolet light source 31, it is noted ultraviolet light source 31 needs to be of adequate intensity for an adequate time to enable UV-light curable etchant resist 18 to form a solid etchant resist with no pinholes.

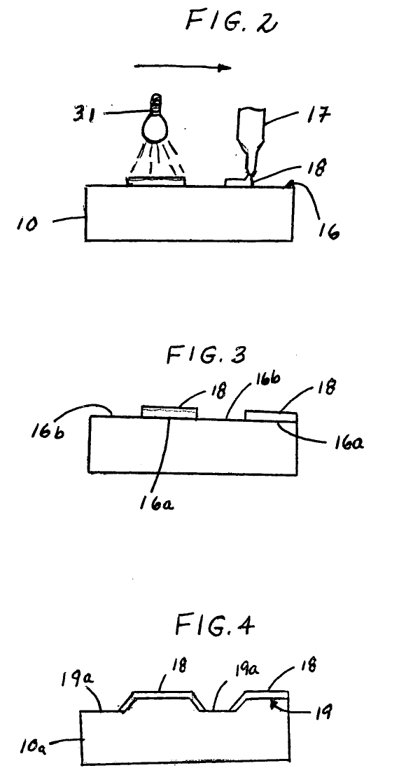

Referring to FIG. 3, the completion of the etchant resist 18 printing process by UV inkjet printer 11 results in substrate 10 having regions 16a of the substrate surface 16 that are covered with UV-cured etchant resist 18 and regions 16b of the substrate surface 16 that are exposed or not covered with UV-cured etchant resist 18.

Referring to FIGS. 1-4, note that after the completion of the UV-light curable etchant resist 18 printing process by UV inkjet printer 11, the surface 16 of substrate 10 containing the UV-cured etchant resist 18 thereon are exposed to an etching process via an acid bath or acid etch 12 to etch the regions 16b of the substrate surface 16 not covered by the UV-cured etchant resist 18 thereby forming a single etched substrate 10a. The etching process via the acid etch 12 comprises contacting the regions 16b of the substrate surface 16 that are exposed or not covered with the UV-cured etchant resist 18 with an etchant that is appropriate for the substrate being etched, for a length of time required to achieve a desired depth of etch. It is noted that typically, 0.001 to 0.025 inches of substrate is removed. For example, for a substrate comprised of magnesium, an etchant comprising nitric acid is normally used. It is noted that typically, 0.001 to 0.025 inches or more of metal may be removed from the region(s) 16b of the substrate surface 16 that is exposed or not covered with the UV-cured etchant resist 18.

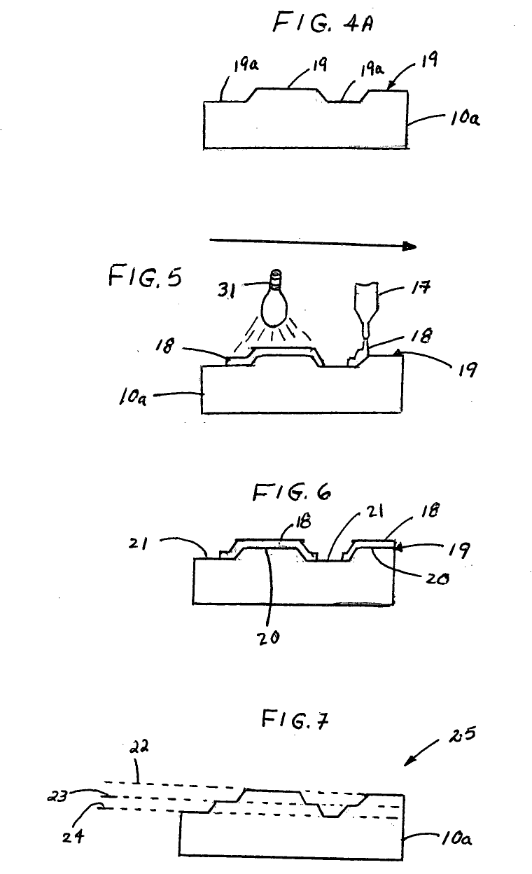

FIG. 4A shows the completion of the etching process resulting in the formation of a substrate 10a having un-etched regions 19 and etched regions 19a with un-etched regions 19 comprised of a surface level of a different elevation than the surface level of etched regions 19a. It is noted that the un-etched regions 19 were protected from the etchant during the acid etch 12 by the etchant resist 18 thereon which still remains thereon as shown in FIG. 4.

It is noted that for certain substrates, a pre-etch descum is also applied to the substrate surface to prevent erratic etching, pimples and scumming on the substrate surface. For example, substrates comprising magnesium or zinc may require the application of a pre-etch descum solution comprising a dilute 5-7% solution of 42° Baume acid, nitric acid, gumarabic, with water. The aforementioned pre-etch descum solution is applied by wiping the pre-etch descum solution across the substrate immediately prior to the etching process.

FIG. 4 shows that the regions 16a of the substrate surface 16 that were covered with the cured etchant resist 18 remain at the original surface level while the regions 16b of the substrate surface 16 that were exposed or not covered with the etchant resist 18 are etched resulting in a substrate surface 19 of different elevations. After the etching process via the acid etch 12 is completed, single etched substrate 10a is then placed through a post etch process 13. In the post etch process 13, single etched substrate 10a is neutralized of any acid that may be left over from the acid etch 12. In addition, single etched substrate 10a is also cleaned of any residue used during the acid etch 12. An example of a possible cleaning agent that may be used in the post etch process 13 include a trisodium phosphate solution in water. It is noted that the post etch process 13 is also necessary so that the UV-cured etchant resist 18 will adhere to the etched single etched substrate 10a once the substrate is run through another round of etching to produce the multi-level embossing die.

After the post etch process 13, the UV-cured etchant resist 18 can be stripped from the single etched substrate 10a using a caustic solution thereby forming a single level embossing die as shown in FIG. 4A.

Although the removal of the cured etchant resist 18 from the single etched substrate 10a is preferred to provide for a clean surface for the UV inkjet printer 11 to print thereon, it is noted that the etchant resist stripping stage 14 of FIG. 1 is optional as the UV inkjet printer 11 is capable of printing over the previously cured etchant resist 18.

Once the cured etchant resist 18 is removed from single etched substrate 10a, single etched substrate 10a is then returned to the UV inkjet printer 11 so that the above etching process is repeated at least once in order to form the multi-level embossing die. More specifically, once the etchant resist 18 is removed from single etched substrate 10a, single etched substrate 10a is then positioned on the printing bed of the UV inkjet printer 11. Another electronic image to be printed onto the substrate is then entered into the computer after which, the computer then sends information to the UV inkjet printer 11 to initiate the printing process.

Referring to FIG. 5, again note that during the printing process the printer head 17 of the UV inkjet printer 11 moves along the single etched substrate 10a leaving droplets of the UV-light curable etchant resist 18 on demand to selected regions on the surface 19 of the single etched substrate 10a while the ultraviolet light source 31 of the UV inkjet printer exposes the UV-light curable etchant resist 18 on the surface 19 of the single etched substrate 10a to ultraviolet light to polymerize or cure the UV-light curable etchant resist 18 to the substrate surface 19. Note that an advantage of employing the inkjet printer 11 in the present invention is that that the inkjet printer 11 is able to apply and cure the etchant resist 18 not only to leveled substrate surfaces but also uneven substrate surfaces and shoulders with repeated precision.

FIG. 6 shows the completion of the etchant resist 18 printing process by the UV inkjet printer 11, which results in the formation of regions 20 of the substrate surface 19 that are covered with the etchant resist 18 and regions 21 of the substrate surface 19 that are exposed or not covered with the etchant resist 18. After the completion of the etchant resist 18 printing process by the UV inkjet printer 11, the single etched substrate 10a is then run through the acid etch 12 to etch the regions 21 of the substrate surface 19 not covered by the cured etchant resist 18.

Once the etching process via the acid etch 12 is completed, the single etched substrate 10a then goes through the post etch process 13 to neutralize and clean single etched substrate 10a after which the etchant resist 18 is then stripped from the single etched substrate 10a thereby resulting in the formation of an embossing die 25 having multi-level surface as shown in FIG. 7. Although embossing die 25 is shown in FIG. 7 as having three different surface levels, namely an original surface level 22, a first etched surface level 23, and second etched surface level 24, the number of surface levels on the embossing die can vary, depending upon the number of times that the embossing die single etched substrate 10a is run through the etching process of FIG. 1.

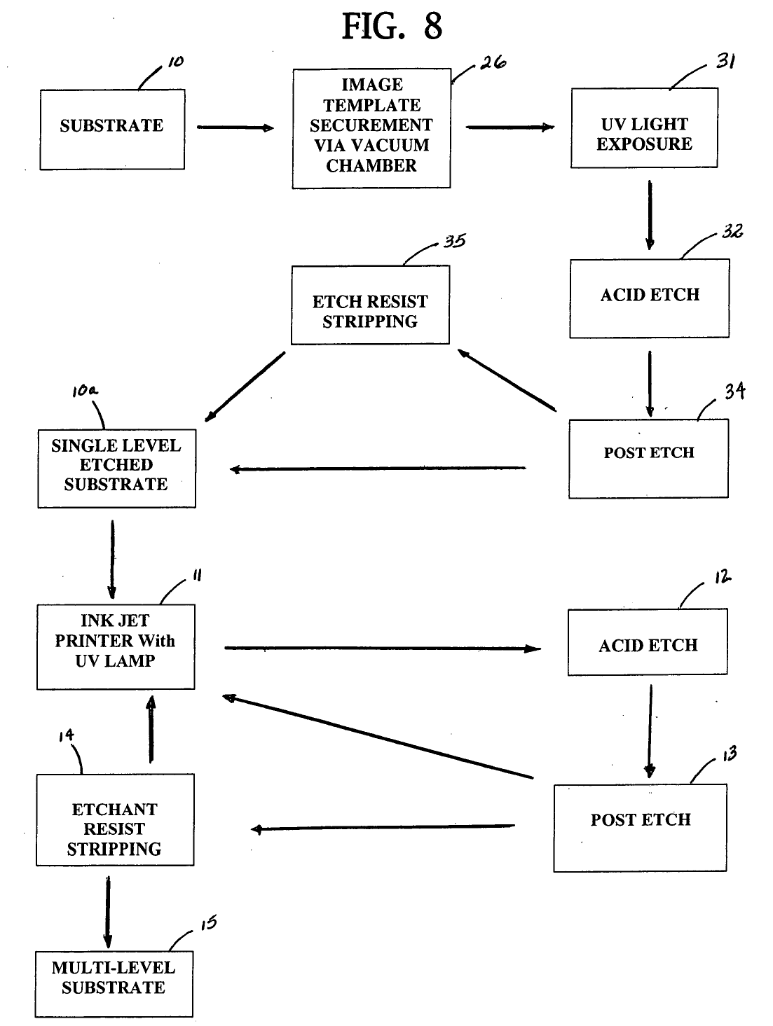

FIG. 8 shows a schematic flow diagram of an alternative embodiment of a method of forming a multi-level embossing die of the present invention. Unlike the method of FIG. 1, which comprises running substrate 10 through a single stage etching process multiple times to form a multi-level embossing die, the method of FIG. 8 comprises a two stage etching process, namely the first stage of forming a single level etched substrate and the second stage forming of a multi-level embossing die from a single level etched substrate.

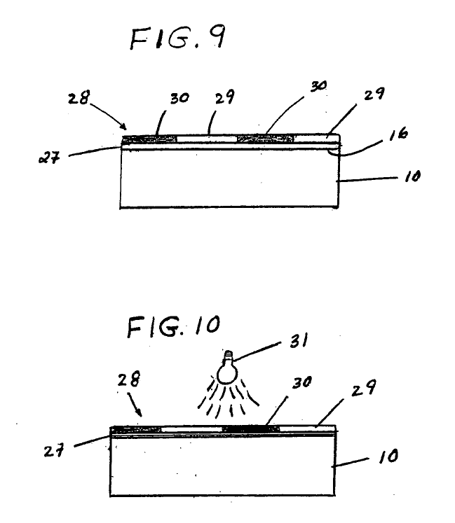

Although the step of forming the single level etched substrate can be accomplished through various methods, such as described in the method of FIG. 1, FIGS. 8 and 9 show the step of forming the single level etched substrate as initiated by the use of an image template 28.

More specifically, in the above step, a negative or positive of the image to be embossed, which hereafter is referred to as image template 28, is initially laid over a surface of a substrate 10 having a coating of a photo sensitive monomer-containing etchant resist 27 located thereon. The image template 28, as shown in FIG. 9 is made up of transparent areas 29 and opaque areas 30. In general, the image template is prepared by using a light sensitive film material, exposing this material in an image setter that produces the output from a CAD (Computer Aided Design) workstation or other source onto the film material. The film material is then processed by developing, fixing and drying. Image template 28 and substrate 10 are then placed in vacuum chamber 26 after which air is removed from the chamber 26 to increase the surface contact between image template 28 and the substrate 10. Referring to FIG. 10, once air is removed from vacuum chamber 26, image template 28 and the substrate 10 is then exposed to ultraviolet light via a UV lamp 31.

During the exposure of the image template 28 and substrate 10 to the ultraviolet light, areas of substrate 10 to remain un-etched are defined by the transparent areas 29 of the image template 28, which allow ultraviolet light to strike and polymerize or cure the photosensitive monomer etchant resist 27 covering the substrate 10. Areas of the photosensitive monomer-containing etchant resist 27 on substrate 10 that were unexposed to the ultraviolet light, i.e. located under the opaque areas 30 of the image template 28, are then easily removed from the substrate thru the developing process as shown in FIG. 11 as they were not cured or polymerized by the ultraviolet light exposure. In regards to ultraviolet light exposure of substrate 10, it is noted that UV lamp 31 needs to be of adequate intensity for an adequate time to enable the photosensitive monomer-containing etchant resist 27 to form a solid etchant resist with no pinholes. That is, as the use life of UV lamp 31 increases, the exposure time required to polymerize or cure the photosensitive monomer etchant resist 27 on the areas of substrate 10 to remain un-etched will increase as the intensity of the UV lamp 31 will likely decrease. The substrate is then put through a developing process to remove the areas of the photosensitive monomer etchant resist 27 that were not exposed to UV lamp 31.

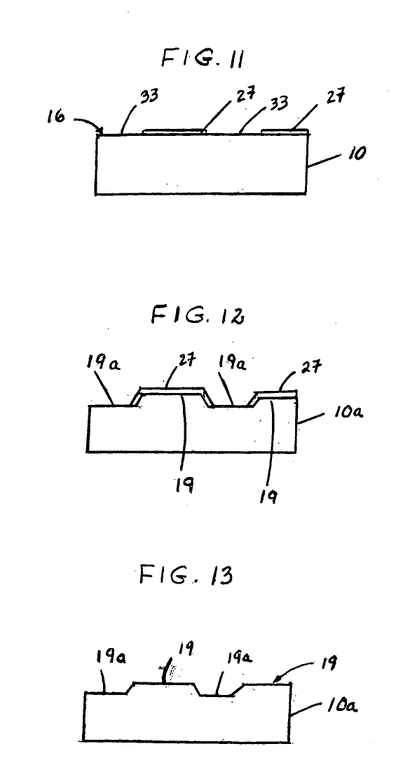

The surface 16 of substrate 10 having the polymerized or cured etchant resist 27 thereon is then exposed to an acid etch 32. During the acid etch 32, the exposed areas 33 of substrate surface 16 or the areas of substrate surface 16 that are not coated with the polymerized or cured etchant resist 27 are etched away with an appropriate etchant for the substrate being etched while the areas of substrate surface 16 coated with the polymerized or cured etchant resist 27 are left un-etched thereby forming single etch substrate 10a having un-etched regions 19 and etched regions 19a as shown in FIG. 12. Similar to the method of FIG. 1, it is noted that for certain substrates, a pre-etch descum is also applied to the substrate surface before the acid etch 32 to prevent erratic etching, and pimples.

Once the etching process via the acid etch 32 is completed, the substrate 10 then goes through a post etch process 34 to neutralize and clean substrate 10 as shown in FIGS. 1 and 13.

After the post etch process 34, substrate 10 goes through an etchant resist stripping process 35 during which a mixture of water and caustic soda is used to remove the polymerized or cured etchant resist 27 from the substrate 10 thereby producing a clean single level etch substrate 10a having an uneven substrate surface 19 as shown in FIG. 13 which signals the completion of the first stage of the method of FIG. 8. In regards to the etchant resist stripping process 35, although the removal of the polymerized or cured etchant resist 27 from the substrate 10 is preferred to provide for a clean surface for the UV inkjet printer 11 to work on, it is noted that the etchant resist stripping process 35 is optional as the UV inkjet printer 11 is capable of printing over the polymerized or cured etchant resist 27.

After the completion of the first stage, the second stage of the method of FIG. 8 comprising formation of the multi-level embossing die from single etched substrate 10a is initiated by the placement of single etched substrate 10a onto the printing bed of the UV inkjet printer 11. An electronic image to be printed onto the substrate is then transferred to the computer, which, then sends information to the UV inkjet printer 11 to initiate the printing process.

Referring to FIG. 5, during the printing process the printer head 17 of the UV inkjet printer 11 moves along the single etched substrate 10a leaving droplets of the UV-light curable etchant resist 18 on demand to selected regions on the surface 19 of the substrate 10a while the ultraviolet light source 31 of the UV inkjet printer exposes the UV-light curable etchant resist 18 on the surface 19 of the substrate 10a to ultraviolet light to polymerize or cure the UV-light curable etchant resist 18 to the substrate surface 19. Although a UV inkjet printer that dispenses an ink jettable resist that is UV cured is presently described, other ink jettable resists that do not require curing can be used in the present invention.

Referring to FIG. 6, after the completion of the etchant resist 18 printing process by UV inkjet printer 11, and descumming single etched substrate 10a is then placed through the acid etch 12 to etch the regions 21 of the substrate surface 19 not covered by the cured etchant resist 18. Referring to FIG. 7, after the etching process via the acid etch 12 is completed, the single etched substrate 10a then goes through the post etch process 13 to neutralize and clean single etched substrate 10a after which the etchant resist 18 is then stripped from the single etched substrate 10a thereby resulting in the formation of an embossing die 25 having multi-level surface. Similar to the method of FIG. 1, the number of surface levels on the embossing die formed by the method of FIG. 8 can vary, depending upon the number of times that substrate 10a is run through the second stage of the etching process of FIG. 8.

I claim:

1. A method of etching a multi-level substrate comprising the steps of:
printing an image on a substrate having at least two different surface elevations with an ink jet printer containing an ink jettable etchant resist; and
etching the substrate in an etchable region to thereby provide a portion of the substrate with an additional surface elevation.

2. The method of claim 1 including the step of exposing the image printed on the substrate to cure the ink jettable etchant resist to leave an etchant protected region and the etchable region on the substrate.

3. The method of claim 2 including the step of stripping a cured ink jettable etchant resist from the surface of the substrate.

4. The method of claim 1 including the step of positioning the substrate on a printing bed of the ink jet printer.

5. The method of claim 1 including the step of repeating the steps of claim 1 at least once.

6. The method of claim 1 including the step of applying a pre-etch descum to the etchable region of the substrate.

7. The method of claim 1 including the step of forming the substrate having at least two different surface levels by:
printing an image on an un-etched substrate with the ink jet printer containing the ink jettable etchant resist;
exposing the image printed on the un-etched substrate to cure the ink jettable etchant resist to leave an etchant protected region and an etchable region on the un-etched substrate; and
etching the un-etched substrate in the etchable region to thereby provide a substrate with at least two different surface levels.

8. The method of claim 7 including the step of applying a pre-etch descum to the surface of the un-etched substrate containing the printed image.

9. The method of claim 1 including the step of forming the substrate having at least two different surface levels by:
laying an image template over a coating of a photosensitive etchant resist located on a surface of an un-etched substrate;
placing the image template and the un-etched substrate in a vacuum chamber and removing air from the vacuum chamber to increase the surface contact between the image template and the un-etched substrate;
exposing the image template and the un-etched substrate to ultraviolet light to cure selected regions of the photosensitive etchant resist to leave an etchant protected region and the etchable region on the un-etched substrate
etching the un-etched substrate in the etchable region to thereby provide a substrate with at least two different surface levels.

10. The method of claim 9 wherein the step of etching the un-etched substrate comprises running the un-etched substrate through an acid etch.

11. The method of claim 9 including the step of stripping the etchant resist from the etchant protected region of the substrate.

12. The method of claim 9 including the step of applying a pre-etch descum to the surface of the un-etched substrate containing the cured etchant resist.

13. A method of etching a multi-level substrate comprising the steps of:
printing an image on a substrate having an original surface level and an etched surface level with an ink jet printer containing an ink jettable etchant resist;
curing the ink jettable etchant resist on the substrate to leave an etchant protected region and an etchable region on the substrate;
etching the substrate in the etchable region to thereby provide the substrate with an additional etched surface level with the additional etched surface level having an elevation different from the elevation of the etched surface level.

14. The method of claim 13 wherein the step of curing the ink jettable etchant resist on the substrate comprises exposing the image printed on the substrate to an ultraviolet light source to cure the ink jettable etchant resist on the substrate to leave the etchant protected region and the etchable region on the substrate.

15. The method of claim 13 including the step of neutralizing and cleaning the substrate after etching the substrate.

16. The method of claim 13 including the step of stripping the cured ink jettable etchant resist from the surface of the substrate.

17. A multi-level substrate comprising:
a substrate having a first surface located at a first elevation and a second surface located at a second elevation with said first elevation different from said second elevation; and
a layer of ink jettable etchant resist located on said first surface and partially on said second surface to thereby enable one to etch said second surface to an elevation different from said elevation of said first surface and said elevation of said second surface.

18. The multi-level substrate of claim 17 wherein the etchant resist pattern is cured.

19. The multi-level substrate of claim 17 wherein the ink jettable etchant resist comprises a UV-light curable etchant resist.

20. The multi-level substrate of claim 17 wherein the etchant resist pattern is removed from the substrate
